(19) United States
(12) Patent Application Publication
(10) Pub. No.: US 2014/0055241 A1
(43) Pub. Date: Feb. 27, 2014

(54) ALERT SYSTEM

(71) Applicant: Peter D. Higgins, Lincoln, MA (US)

(72) Inventor: Peter D. Higgins, Lincoln, MA (US)

(21) Appl. No.: 13/875,383

(22) Filed: May 2, 2013

Related U.S. Application Data
(60) Provisional application No. 61/691,585, filed on Aug. 21, 2012.

(51) Int. Cl. G08B 27/00

(52) U.S. Cl. CPC G08B 27/00
USPC 340/7.5

(57) ABSTRACT

An alert system includes centrally-located alarm device and a plurality of handheld remote devices, each remote device storing a unique identification code. Upon a primary depression of an externally-accessible actuation button, a mobile device in direct communication with each remote device transmits a predefined distress message to a predefined emergency responder which can be used to provide immediate assistance. Upon a secondary depression of the actuation button, each remote device transmits a wireless distress signal encoded with its unique identification code that in turn causes the alarm to emit an auditory and visual alarm. An alarm monitoring center is in communication with the alarm device and automatically receives historical data relating to activation of the alarm device, the historical data including, for instance, the identification code of the remote unit responsible for activation of the alarm device as well as the time and date of the transmitted distress signal.

### FIELD OF THE INVENTION

The present invention relates generally to personal protection and more particularly to non-injurious devices that are designed to protect an individual from a physical attack.

### BACKGROUND OF THE INVENTION

Due to an increasing rate of violent physical attacks on unsuspecting victims, a greater consciousness has been directed toward teaching useful self-defense techniques. In particular, it is important that individuals who are smaller in stature, such as young, petite women, learn tactics for warding off unprovoked acts of physical aggression.

As one self-defense technique, individuals are often armed with weapons to protect themselves from violent attacks. Although well-known and widely used in the art, handheld weapons, such as firearms and electroshock devices, are often disfavored by certain individuals who are uncomfortable imparting injury onto another person, even when in response to a physical attack. Moreover, it has been found that most injurious self-defense weapons are relatively large in size and, as such, are not always readily available for immediate use in a time of crisis.

As another self-defense technique, individuals are often armed with non-injurious alarm devices, such as whistles and handheld panic alarms, which emit a loud auditory signal when activated. By producing a relatively loud alarm, the device serves to notify other individuals in the immediate area of the attack, thereby deterring the attacker from engaging in any further action of physical aggression.

Although well-known and widely used in the art, non-injurious alarm devices of the type as described above have been found to suffer from a few notable shortcomings.

As a first shortcoming, non-injurious alarm devices have a limited range of effectiveness. In particular, non-injurious alarm devices are often ineffective in relatively vast and isolated environments, such as parking lots, parks and campuses, since an auditory signal produced by such a device may be out of earshot from a third party.

As a second shortcoming, non-injurious alarm devices are often activated in an accidental manner. For instance, when handling a keychain, individuals occasionally depress the panic button provided on the rear of an automobile remote which, in turn, activates a car alarm. Due to the frequency of inadvertent activation of non-injurious alarm devices, people in the immediate environment are often unaware whether an individual is experiencing an actual moment of crisis and, as a result, often fail to provide necessary assistance.

As a third shortcoming, non-injurious alarm devices are not typically linked together in any manner and therefore provide no means to compile historical data relating to triggered alarms within a particular region. Accordingly, individuals responsible for ensuring personal safety within a defined area are unable to evaluate important safety information including, but not limited to, the location and time of activated alarms as well as the name of the individual responsible for triggering each alarm.

As a fourth shortcoming, non-injurious alarm devices are not typically designed to pinpoint to rescuers the exact location of the individual who triggered the alarm. Consequently, a rescuer is not always able to readily find the individual responsible for activating an auditory distress alarm.

### SUMMARY OF THE INVENTION

It is an object of the present invention to provide a new and improved alert system.

It is another object of the present invention to provide a new and improved alert system that is readily accessible, easily to handle and simple to use.

It is yet another object of the present invention to provide a new and improved alert system of the type as described above that has a wide range of effectiveness.

It is still another object of the present invention to provide a new and improved alert system that allows for the immediate identification of the location of an individual sending a distress signal.

It is yet still another object of the present invention to provide a new and improved alert system of the type as described above that allows for the compilation of historical activation data.

It is yet still another object of the present invention to provide a new and improved alert system that that includes a minimal number of parts, is largely automated in nature and is inexpensive to manufacture and maintain.

Accordingly, as one feature of the present invention, there is provided an alert system, comprising (a) a plurality of individual remote units, each remote unit being adapted to selectively transmit a wireless distress signal, and (b) a plurality of individual mobile devices, each mobile device being in direct communication with a corresponding remote unit, (c) wherein each mobile device is adapted to initiate a predefined distress message to a predefined emergency responder upon receiving the wireless distress signal transmitted by the corresponding remote unit.

Various other features and advantages will appear from the description to follow. In the description, reference is made to the accompanying drawings which form a part thereof, and in which is shown by way of illustration, various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a simplified block diagram of an alert system constructed according to the teachings of the present invention;

FIGS. 2(a)-(d) are left, front, top and perspective views, respectively, of one of the remote units shown in FIG. 1;

FIG. 3 is a simplified schematic representation of the remote unit shown in FIG. 2(a);

FIG. 4 is a simplified schematic representation of the alarm device shown in FIG. 1; and

FIG. 5 is a simplified diagram of an exemplary data structure for the data storage device shown in FIG. 1.

### DETAILED DESCRIPTION OF THE INVENTION

### Alert System 11

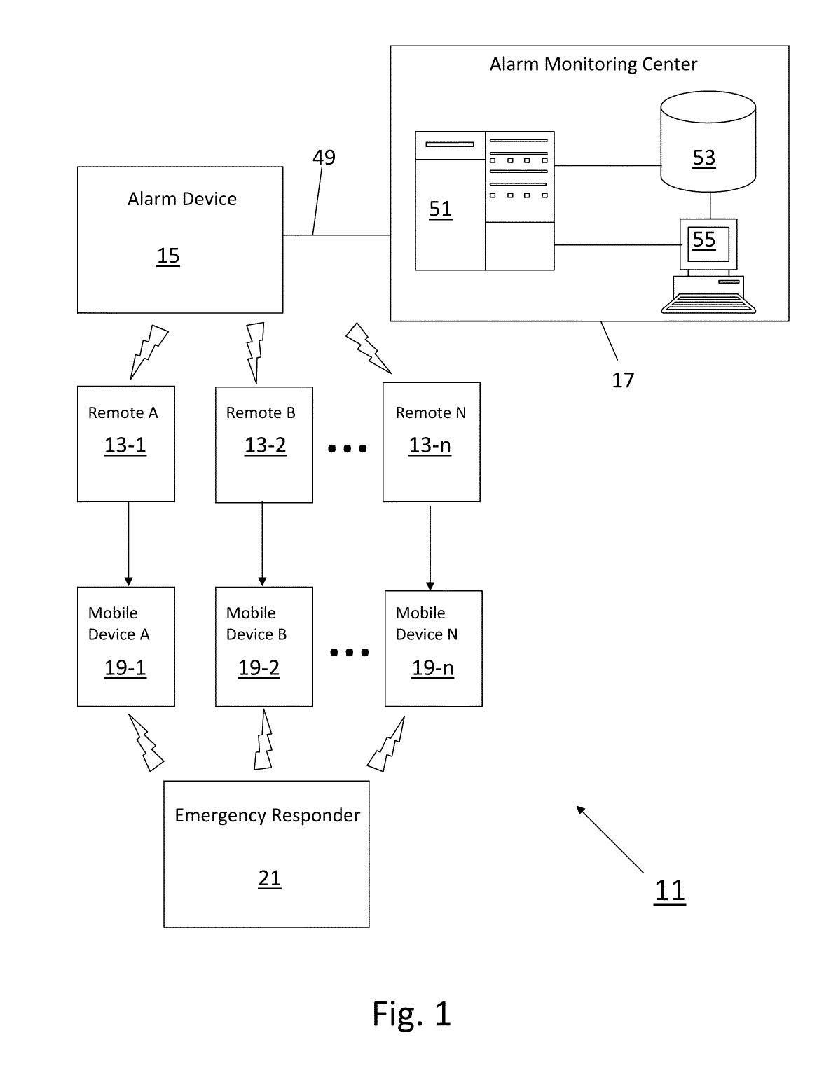

Referring now to FIG. 1, there is a shown a simplified block diagram of an alert system constructed according to the teachings of the present invention, the system being identified generally by reference numeral 11. In use, system 11 can be used to not only provide an alert that an individual is in distress in a simple, secure, reliable, and inexpensive manner but also compile historical data relating to alert signals generated, which is a principal object of the present invention.

As can be seen, alert system 11 comprises a plurality of individual remote units, or remotes, 13-1 thru 13-n that are designed to trigger activation of at least one common alarm device, or alarm, 15. In turn, alarm device 15 is electronically linked with an alarm monitoring center 17 which automatically compiles historical alarm activation data that can be used, inter alia, to track and analyze the occurrence of initiated alarms in order to improve general public safety, which is highly desirable.

In the present embodiment, remote units 13-1 thru 13-n are shown linked with mobile devices 19-1 thru 19-n, respectively, wherein each mobile device 19 preferably represents any handheld device with at least one-way telephonic and/or messaging capabilities, such as a cellular telephone. As will be described further below, each remote unit 13 is designed to communicate with its corresponding mobile device 19 via wireless communication means, such as Bluetooth wireless technology, and in turn cause device 19 to initiate a distress message to an emergency responder 21. In this capacity, emergency responder 21 can track the location of the person in distress using global positioning system (GPS) data from the corresponding mobile device 19 and, in turn, provide immediate assistance.

Referring now to FIGS. 1-3, each remote unit 13 is constructed as a small, unitary, handheld unit that is preferably the general size and shape of a tube of lipstick. Due to its relative small size and ease in handling, it is envisioned that each remote unit 13 could be inconspicuously held within the palm of its owner when traveling in environments with relatively dangerous conditions. Although not shown herein, it is similarly envisioned that each remote unit 13 could be directly worn on its owner (e.g., as a bracelet, pendant or clip) to promote continuous availability and accessibility.

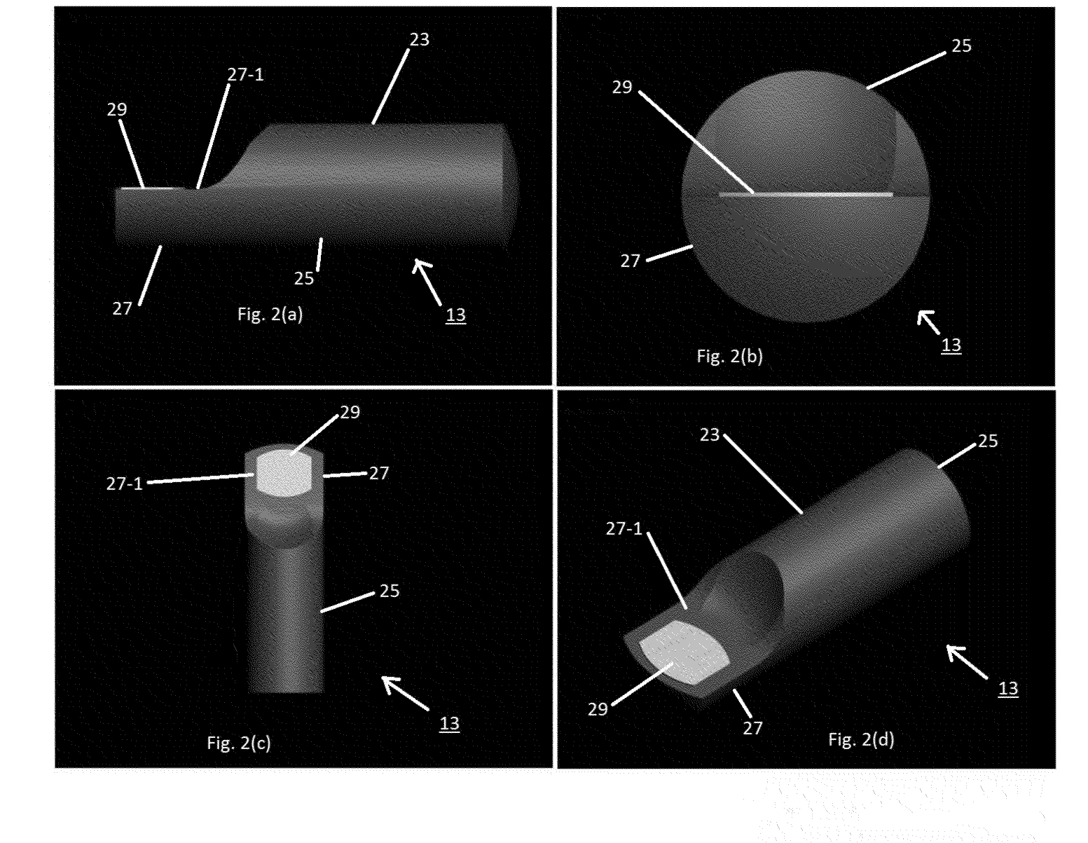

As seen most clearly in FIGS. 2(a)-(d), each remote unit 13 comprises a unitary, lipstick-sized, outer protective housing 23 that is constructed out of a rigid and durable material, such as plastic. As can be seen, housing 23 includes a hollow, tubular portion 25 and a semi-cylindrical portion 27 extending outward from one end of tubular portion 25 in coaxial alignment therewith. As a feature of the present invention, the particular design of remote unit 13 allows for inconspicuous handling and operation, with tubular portion 25 ergonomically fitting within the closed first of the handler and semi-cylindrical portion 27 disposed to receive the thumb of the handler.

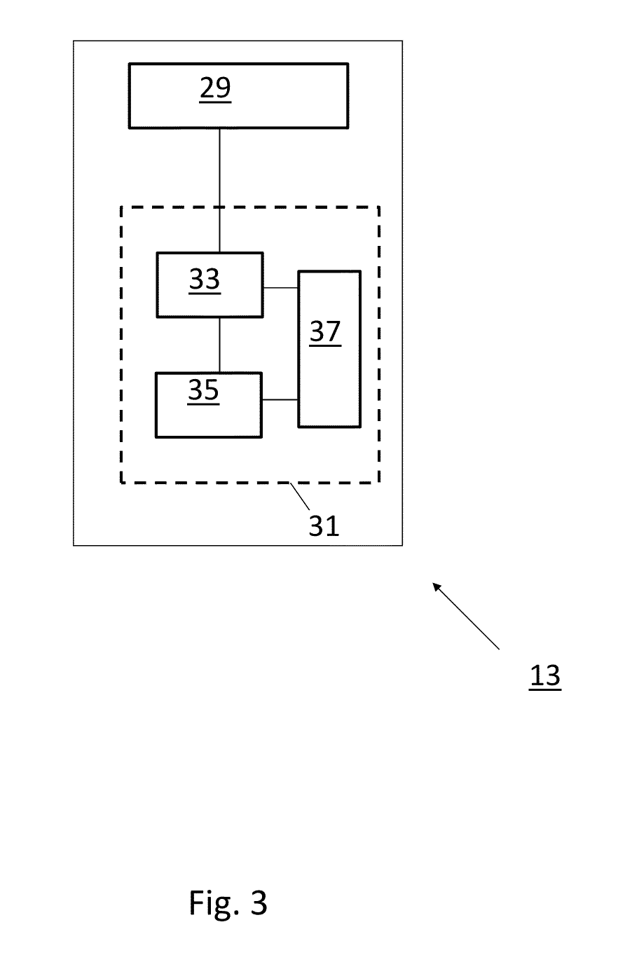

An externally-accessible actuation button, or sensor, 29 is mounted onto flattened top surface 27-1 of semi-cylindrical portion 27. Actuation button 29 is in turn electrically connected by conductive wiring to electronics 31, which is disposed within the interior of tubular portion 25. As seen most clearly in FIG. 3, electronics 31 comprises a central controller, or processor, 33 for regulating the primary operations of remote unit 13, a transmitter 35 electrically connected to processor 33 and a power source 37, such as one or more batteries, electrically connected to both processor 33 and transmitter 35. In use, upon sensing the depression of actuation button 29, processor 33 causes transmitter 35 to wirelessly send one or more types of distress signals, the details of which will be described further in detail below.

Although not shown herein, it is to be understood that electronics could additionally include a miniature camera that is electronically connected to both processor 33 and power source 27, with the camera located in any suitable location in housing 23 (e.g., in the free end of tubular portion 25). As can be appreciated, the camera would be able to collect and transmit images, either in individual or video form, which can be used to gather information.

Referring back to FIG. 1, alert system 11 is shown with n-number of remote units 13. As will be described further below, it is envisioned that each remote unit 13 is assigned a unique identification (ID) code and is registered to a particular individual prior to issuance, with the registration data retained by alarm monitoring center 17. Accordingly, it is to be understood that the total number of remotes 13 utilized within system 11 could be increased or decreased depending upon the particulars of the intended application.

As previously noted, each remote unit 13 is designed to transmit a distress signal to alarm device 15 using any known wireless communication means, such as radio frequency (RF) communication means. In response, alarm device 15 is designed to (i) emit an alarm and (ii) transmit information relating to the distress signal to alarm monitoring center 17, as will be described further below.

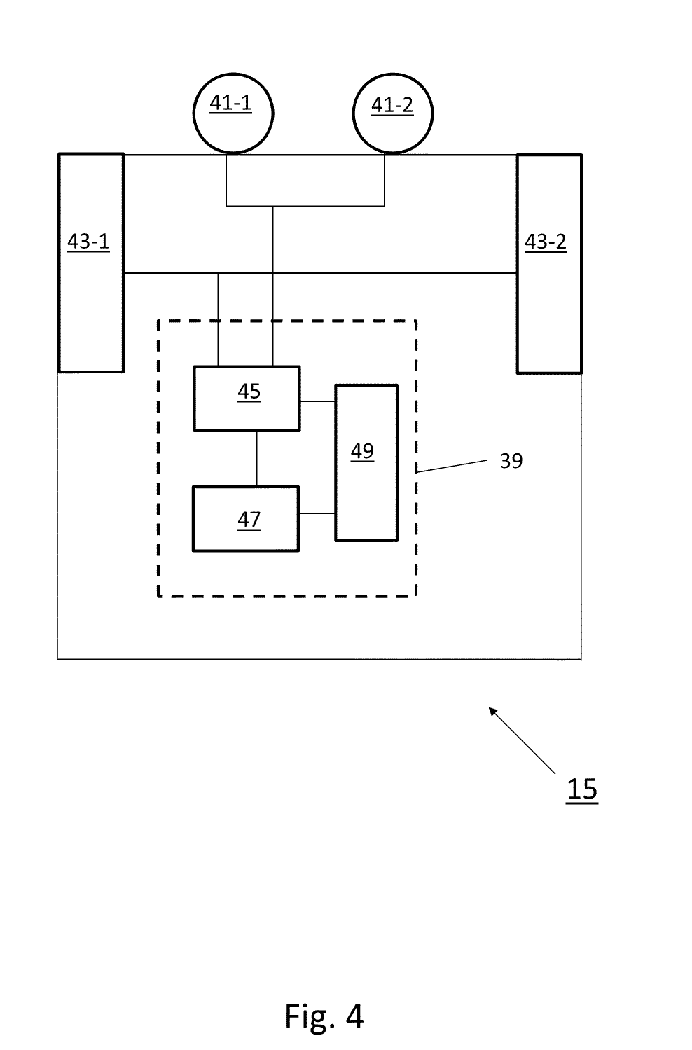

As seen most clearly in FIG. 4, alarm device 15 is preferably constructed as a unitary device that is centrally located within a designated area (e.g., in the center of a darkened parking garage). Alarm device 15 preferably includes internally housed electronics 39 that is electrically connected to both a pair of lights 41-1 and 41-2, and a pair of speakers 43-1 and 43-2, with the particular number of lights 39 and speakers 41 being modifiable without departing from the spirit of the present invention.

Electronics 39 includes a central controller, or processor, 45 for regulating the primary operations of alarm device 15, a receiver 47 electrically connected to processor 45 and a power source 49, such as one or more batteries, electrically connected to both processor 45 and receiver 47. In use, upon receipt of a distress signal by receiver 47, processor 45 causes lights 41 to display a visual signal (e.g., a bright flashing light) and speakers 43 to produce an auditory signal (e.g., a loud siren). Furthermore, processor 45 further transmits data relating to the distress signal to alarm monitoring center 17 via communication path 49 for storage and analysis, which will be described further in detail below.

It should be noted that system 11 is not limited to a single alarm device 15. Rather, it is to be understood that numerous alarm devices 15, each capable of activation by remotes 13, could be disposed at various locations within a protected region to provide further security without departing from the spirit of the present invention.

Referring back to FIG. 1, alarm monitoring center 17 functions a data collection hub that is locally or remotely located relative to alarm device 15. In the present invention, center 17 is shown comprising a central server 51 in electronic communication with alarm device 15 via communication path 49, such as a local area network (LAN). Server 51 is designed to receive data relating to distress signals sent from remotes 13 to alarm device 15 and, in turn, store the data into a database 53. Using a compute device 55, personnel at alarm monitoring center 17 can regulate operation of server 51 and analyze data from database 53, as will be described further below.

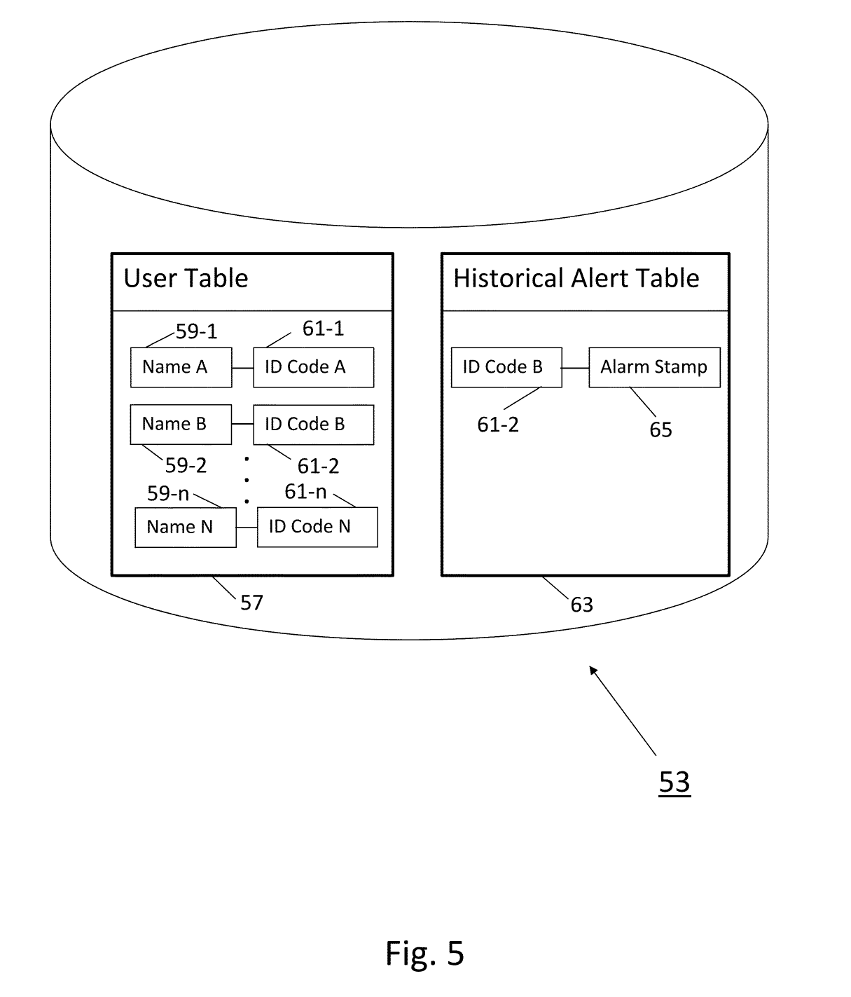

As seen most clearly in FIG. 5, data collected in database 53 is preferably grouped into a plurality of tables to provide greater ease in data mining.

For instance, database 53 preferably includes a user table 57 that links user registration information (e.g., the name and contact information of the registered individual) with the unique identification code assigned to each remote 13. In the present example, user registration data 59-1 thru 59-n is shown linked with unique identification codes 61-1 thru 61-n, respectively. In this capacity, table 57 efficiently associates each remote device 13 with the key information relating to the individual to which it is registered.

Additionally, database 53 preferably includes a historical alert table 63 that links information relating to the trigger of alarm device 15 (e.g., the date/time when alarm 15 was triggered) with the unique identification code 61 of the remote 13 responsible for the triggering of alarm device 15. In the present example, an alarm stamp 65 is shown linked with unique identification code 61-2. Accordingly, user table 57 and history table 63 enables an analyst to evaluate key historical information relating to the activation of alarm device 15 (e.g., date, time, location, and name of distressed individuals) in order to promote greater safety.

### Operation of System 11

Alert system 11 can be used in the following manner to provide assistance to a person in distress. As referenced above, each remote unit 13 is assigned a unique identification code that is stored in its controller 45. As part of the process for registering a remote unit 13 to an individual, the unique identification code for each remote unit 13 is then linked with pertinent information relating to the person to whom it is issued (e.g., the name, address, cell phone number, etc.) and stored within database 53 in user table 57. In this manner, monitoring center 17 can readily associate each remote 13 with its rightful carrier.

When in immediate physical distress, the individual depresses actuation button 29 of his/her remote 13 a first time. This first actuation of remote 13 causes controller 33 to instruct transmitter 35 to send a first alert signal to the mobile device 19 linked thereto, the mobile device 19 preferably being located in close proximity to the person (e.g., in a purse or coat pocket). In response, mobile device 19 is preprogrammed to send a distress message to a predetermined, yet modifiable, emergency responder 21, such as a family member, neighbor or police officer, wherein the telephone number of specified emergency responder 21 is preloaded into mobile device 19 as part of an initial set-up process. The distress message is preferably sent to responder 21 by any wireless communication means, such as by short message service (SMS) text message or email. The alert message is preferably predefined, modifiable, and appropriate for the emergency, such as, “please help immediately.” In this capacity, emergency responder 21 can take immediate action to assist the individual in distress, for example, by utilizing the GPS data associated with mobile device 19.

As mentioned briefly above, mobile device 19 requires at least one-way message transmission capabilities. Accordingly, mobile device 19 could be in the form of either a standard, two-way messaging device, such as traditional mobile telephone, or a one-way, transmit-only, messaging device (i.e., an emergency cellular device).

Although not shown herein, it is to be understood that each remote unit 13 could be alternatively constructed to allow for the transmission of the alert message directly to emergency responder 21, thereby eliminating the need for mobile devices 19. Specifically, it is envisioned that electronics 31 include means for directly transmitting the predefined, modifiable alert message to emergency responder 21 and, at the same time, additionally include GPS capabilities that allow for direct tracking of the location of each remote unit 13. As can be appreciated, this alternative to system 11 could be implemented, for example, by simply utilizing a central processor 33 with both messaging and GPS capabilities.

If further assistance is required, the individual can depress actuation button 29 of his/her remote 13 a second time, which results in the transmission of an alert signal to alarm device 15. Although not shown herein, it is also envisioned that each remote 13 could be alternatively constructed to include two separate actuation buttons 29, with one button designated for the transmission of a distress signal to emergency responder 21 and the other button designated for the transmission of an alert signal to alarm device 15.

In response to the depression of actuation button 29 a second time, controller 33 instructs transmitter 35 to send an alert signal to alarm device 15, the alert signal being preferably encoded with the unique identification code stored in controller 33. In this manner, the alert signal transmitted is associated with a particular remote unit 13.

As noted previously, alarm device 15 is preferably situated in a central, highly visible location, such as mounted high on a light post or beam in a parking lot, campus or other similar environment. Upon receipt of the alert signal by receiver 37, controller 45 for centrally-located alarm device 15 causes lights 41 to display a bright visual signal and speakers 43 to emit a loud auditory signal. As can be appreciated, the sight and sounds of the alarm produced by device 15 is intended to disrupt further physical attack by the aggressor on the victim. Simultaneously, the data relating to the alert signal is transmitted by controller 45 to alarm monitoring center 17 where is it is stored within historical alert table 63 in database 53.

As noted previously, alert table 63 compiles all historical data associated with the activation of alarm device 15, including the date/time of each alarm with the individual responsible for activation. In this manner, personnel at alarm monitoring center 17 can establish alarm patterns, such as increased alarm activation during certain hours or unusual alarm activation by one or more individuals. This information can then be used to foster greater safety within the protected region, which is a principal object of the present invention.

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. An alert system, comprising:
(a) a plurality of individual remote units, each remote unit being adapted to selectively transmit a wireless distress signal; and
(b) a plurality of individual mobile devices, each mobile device being in direct communication with a corresponding remote unit;
(c) wherein each mobile device is adapted to initiate a predefined distress message to a predefined emergency responder upon receiving the wireless distress signal transmitted by the corresponding remote unit.

2. The alert system of claim 1 wherein each of the predefined distress message and the predefined emergency responder is modifiable.

3. The alert system of claim 1 further comprising an alarm device adapted to be selectively activated, the alarm device generating an alarm signal upon activation, each remote unit being adapted to selectively transmit a wireless distress signal that activates the alarm device.

4. The alert system of claim 3 wherein each remote unit comprises:
(a) electronics for selectively transmitting the wireless distress signal; and
(b) a depressible actuation button that is electrically connected to the electronics;
(c) wherein the electronics transmits the wireless distress signal in direct response to depression of the actuation button.

5. The alert system of claim 4 wherein the remote unit includes an outer housing for protecting at least a portion of the electronics.

6. The alert system of claim 5 wherein the outer housing comprises:
(a) a hollow tubular portion; and
(b) a semi-cylindrical portion extending outward from one end of the tubular portion in axial alignment therewith.

7. The alert system of claim 3 wherein each remote unit is assigned a unique identification code, the wireless distress signal transmitted by each remote unit being encoded with the corresponding identification code for the remote unit.

8. The alert system of claim 7 wherein the electronics for each remote unit comprises:
(a) a transmitter for transmitting the wireless distress signal; and
(b) a central controller electrically connected to the transmitter, the central controller regulating transmission of the wireless distress signal by the transmitter, the central controller storing the unique identification code for the remote unit.

9. The alert system of claim 7 wherein the alarm device, upon activation, is adapted to generate at least one of a visual signal and an auditory signal.

10. The alert system of claim 9 wherein the alarm device comprises:
(a) a receiver for receiving the wireless distress signal; and
(b) a central controller electrically connected to the receiver, the central controller regulating the generation of the alarm signal in response to receipt of the wireless distress signal.

11. The alert system of claim 10 wherein the alarm device includes at least one light in electrical connection with the central controller, the central controller illuminating the at least one light in response to the receipt of the wireless distress signal.

12. The alert system of claim 10 wherein the alarm device includes at least one speaker in electrical connection with the central controller, the central controller causing the at least one speaker to emit an auditory alarm in response to the receipt of the wireless distress signal.

13. The alert system of claim 7 further comprising an alarm monitoring center that is in communication with the alarm device.

14. The alert system of claim 13 wherein the alarm monitoring center automatically compiles historical data relating to activation of the alarm device.

15. The alert system of claim 14 wherein the historical data compiled by the alarm monitoring center includes the unique identification code encoded in the distress signal responsible for activation of the alarm device.

16. The alert system of claim 15 wherein the historical data compiled by the alarm monitoring center additionally includes a temporal stamp for the distress signal responsible for activation of the alarm device.

17. The alert system of claim 16 wherein the historical data compiled by the alarm monitoring center links the unique identification code associated with activation of the alarm device with the corresponding temporal stamp.

18. The alert system of claim 17 wherein the temporal stamp includes information relating to a date and a time of each transmitted distress signal received by the alarm device.

19. The alert system of claim 18 wherein the alarm monitoring center comprises:
(a) a server in communication with the alarm device, and
(b) a database for storing the historical data.

20. An alert system, comprising:
(a) a remote unit adapted to selectively transmit a wireless distress signal; and
(b) a mobile device in direct communication with a corresponding remote unit;
(c) wherein the mobile device is adapted to initiate a predefined distress message to a predefined emergency responder upon receiving the wireless distress signal transmitted by the remote unit.
